(19) United States
(12) Patent Application Publication
(10) Pub. No.: US 2011/0294947 A1
(43) Pub. Date: Dec. 1, 2011

(54) PAINT COMPOSITION

(75) Inventors: Andreas Poppe, Shanghai (CN); Günter Klein, Munster (DE); Oliver Hilge, Drensteinfurt (DE); Rui Niimi, Yokohama (JP)

(73) Assignee: BASF COATINGS GMBH, Munster (DE)

(21) Appl. No.: 13/142,127

(22) PCT Filed: Dec. 23, 2009
(86) PCT No.: PCT/EP09/09254

§ 371 Date: Aug. 22, 2011

(30) Foreign Application Priority Data
Dec. 24, 2008 (DE) 102008063085.3

(51) Int. Cl. C09D 133/08

(52) U.S. Cl. 524/558

(57) ABSTRACT

The present invention relates to coating compositions comprising at least one binder and at least one curing agent. The curing agent comprises an aliphatic polyisocyanate and a CH-acidic compound. The compositions are suitable for use in clearcoats.

The invention relates to a coating composition comprising at least one binder and at least one curing agent. The compositions in question are what are known as two-component coating materials, where binder component and curing component are mixed not until shortly before application. The invention further relates to the use of the coating composition in clearcoats.

DE 27 23117 C2 describes a one-component baking varnish with an OH monomer, an aminoplast crosslinker, and a component which comprises a “capped” diisocyanate unit. The intention with this composition is to provide liquid baking varnishes having a high solids content. Coating materials of this kind comprising blocked isocyanates exhibit good gloss and hardness properties.

DE 23 42 603 describes a process for preparing malonic ester adducts by reacting malonic esters with aliphatic biuret compounds. The mixture has the advantage that it can be diluted with typical paint solvents to give a clear composition.

DE 25 50 156 discloses a process for preparing polyisocyanate mixtures which comprise blocked isocyanates. Such mixtures can be used in polyurethane baking varnishes.

DE 24 36 872 describes a process for preparing a compound from malonic ester and a diisocyanate in the presence of catalytic amounts of an alkoxide. The intention with this process is to prepare a capped diisocyanate which finds use in particular in coating materials and has good processing properties.

The prior art, accordingly, has disclosed coating compositions which comprise polyisocyanates blocked with CH-acidic compounds. For the reaction between polyisocyanate and CH-acidic compound it is preferred to use alkoxides or phenoxides as catalysts. In other words, for successful blocking of polyisocyanates with CH-acidic compounds, strong bases are always used. The reaction is carried out at elevated temperature, at 80° C., for example.

The prior art makes no mention, however, of coating compositions having advantageous properties that comprise both (poly)isocyanates and CH-acidic compounds, without a reaction occurring between (poly)isocyanates and CH-acidic compounds.

It is an object of the present invention to provide coating compositions which exhibit enhanced compatibility with millbases, exhibit an improved surface quality (appearance), and exhibit good hardness.

This object is achieved by the technical teaching of the independent patent claims. Advantageous developments are found in the dependant claims, the description, and the examples.

Surprisingly it has been found that a coating composition comprising at least (a) a binder and (b) at least one curing agent, characterized in that the curing agent comprises or consists of a mixture of at least one (b1) aliphatic polyisocyanate and at least one (b2) CH-acidic compound, achieves the object.

A reaction between (poly)isocyanates and CH-acidic compounds is in this case unwanted and is if possible to be avoided. This can be achieved through the absence of basic catalysts and the avoidance of temperatures above 90° C.

As component (a) of the coating composition of the invention a binder is used. Suitable binders react with the NCO groups of the curing agent mixture. Particularly suitable binders are all resins which carry OH groups, such as polyester polyols, polyether polyols, (meth)acrylate polyols or else mixtures thereof, for example.

The curing agent (b) of the invention comprises the polyisocyanate (b1) and the CH-acidic compound (b2). By CH-acidic compound are meant compounds which do not possess basic properties but which can be deprotonated in the presence of bases (see the collectively authored “Organikum”, Deutscher Verlag der Wissenschaften, 1990, p. 442 ff.).

Polyisocyanates (b1) used are aliphatic and cycloaliphatic polyisocyanates which carry at least two NCO groups per molecule. Preference is given to using diisocyanates, such as, for example, 3-isocyanatomethyl-3,3,5-trimethylcyclohexyl isocyanate (IPDI) and hexamethylene diisocyanate (HDI). The structural formulae of IPDI and HDI are shown below.

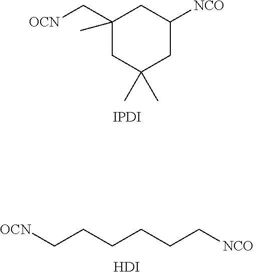

It is also possible to use derivatives of polyisocyanates, such as an isocyanurate-based oligomeric or polymeric derivative of one or more aliphatic polyisocyanates, preferably an isocyanurate-based oligomeric or polymeric derivative of hexamethylene diisocyanate and/or isophorone diisocyanate.

The CH-acidic compound (b2) can be selected from the group of β-dicarbonyl compounds. Examples, but without limitation, of the group of these compounds include acetylacetone, ethyl acetoacetate, malonic acid and derivatives thereof, methyl 2-cyanoacetate, ethyl 3-oxobutanoate, and propanedinitrile. The pKₐ values of these compounds are situated in a range from 5 to 15, more preferably in a range from 9 to 13 (in this regard see also the listing of the substances in K. P. C. Vollhardt, Organische Chemie, VCH-Verlag, 1990, p. 1038.). Preferred compounds for the purposes of the invention are in particular the derivatives of malonic acid, such as dimethyl malonate and diethyl malonate, for example, and also ethyl acetoacetate.

The at least one CH-acidic compound (b2) has a molecular weight of 90-400 g/mol, preferably of 90-200 g/mol, more preferably of 120-200 g/mol.

The molar ratio of the reactive groups of the binder to the reactive groups of the polyisocyanate is 0.9:1 to 1:0.9. Particular preference is given to a molar ratio of 1:1, in order to maximize conversion of all the reactive groups when the coating composition is cured.

The ratio of the weight fractions of components (b1) and (b2) is between (b1):(b2)=15:1 and (b1):(b2)=1.5:1, preferably between (b1):(b2)=12:1 and (b1):(b2)=2:1.

The composition may as a further component (c) comprise at least one polymeric amine. By polymeric amines are meant those amines which have a molar mass of 1000 g/mol-50 000 g/mol, determined as the Mw (Mw=weight average) of the molecular weight. Preferably the molar mass of the polymeric amines is 1000 g/mol-30 000 g/mol, and more preferably 1000 g/mol-20 000 g/mol.

On the calculation of the weight-average molecular weight see: B. Tierke, Makromolekulare Chemie, VCH-Verlag, Weinheim, 1997, p. 206 ff., by GPC. In the case of substances which are composed essentially of only one molecule and have no molar mass distribution, the molecular weight can be looked up in the common literature. In the case of substances which have a molar mass distribution, the weight average of the molecular weight, Mw, is determined by means of static light scattering and employed as the molecular weight (in this regard see: “Die Grundlagen der statischen Lichtstreuung” in M. D. Lechner, K. Gehrke, E. H. Nordmeier, “Makromolekulare Chemie”, Birkhäuser Verlag, 1993, p. 208 ff.). It is preferred to use polymeric amines having amphiphilic properties.

The polymeric amine (c) contains preferably fatty acid groups, siloxane or polysiloxane groups or polyolefin groups. With particular preference the amine contains siloxane or polysiloxane groups.

The amine number of the polymeric amines is 2 mg KOH/g to 40 mg KOH/g, preferably 4 mg KOH/g to 30 mg KOH/g, and more preferably 5 mg KOH/g to 30 mg KOH/g.

On the definition and calculation of the amine number, reference is made herein to Th. Brock, M. Groteklaes, P. Mischke, “Lehrbuch der Lacktechnologie”, Vincentz Verlag, p. 78. The amine number is determined in accordance with DIN 53176 by means of a potentiometric titration.

The amine (c) is present in the coating composition preferably at 1%-4% by weight and more preferably at 1.5%-2.5% by weight, based on the overall formulation of the curing agent.

The coating composition of the invention is used preferably in clearcoats. The clearcoats are curable clearcoat materials.

A clearcoat which comprises the coating composition of the invention is curable thermally or both thermally and with actinic radiation. This thermal curing, or curing both thermally and with actinic radiation, may be assisted by physical curing.

In the context of the present invention the term “physical curing” means the formation of a film as a result of loss of solvent from polymer solutions or dispersions. Typically no crosslinking agents are necessary for this curing. Where appropriate the physical curing may be assisted by atmospheric oxygen or by exposure to actinic radiation.

In the context of the present invention the term “thermal curing” means the heat-initiated curing of a layer of a coating material, for which typically a separate crosslinking agent is employed. The crosslinking agent contains reactive functional groups which are complimentary to the reactive functional groups present in the polyurethanes. Typically this is referred to by those in the art as external crosslinking. Where the complimentary reactive functional groups or autoreactive functional groups, i.e., groups which react “with themselves”, are already present in the polyurethanes, the latter are self-crosslinking. Examples of suitable complimentary reactive functional groups and autoreactive functional groups are known from German patent application DE 199 30 665 A1, page 7 line 28 to page 9 line 24.

In the context of the present invention, actinic radiation means electromagnetic radiation such as near infrared (NIR), visible light, UV radiation, x-rays or gamma radiation, especially UV radiation, and particulate radiation such as electron beams, beta radiation, alpha radiation, proton beams or neutron beams, especially electron beams. Curing by UV radiation is typically initiated by free-radical or cationic photoinitiators.

Where thermal curing and curing with actinic light are employed jointly with respect to a coating material of the invention, the term “dual cure” is also used.

Clearcoats which comprise the composition of the present invention are especially suitable for finishing automobile bodies or parts thereof.

The invention is elucidated in more detail below with reference to examples.

### EXAMPLES

### Example 1

### Preparation of Curing Agent H-1

First of all a reactor equipped with a stirrer was flushed with nitrogen gas. Thereafter 1209.9 mass fractions of a polyisocyanate based on hexamethylene diisocyanate and 259.5 mass fractions of diethyl malonate are added. After 20 minutes' stirring at room temperature, 31.5 mass fractions of a polyamine additive were added and the mixture was stirred at room temperature for a further 20 minutes.

The solids content of the resulting curing agent was 81.2%, with an NCO fraction of 17.8%.

### Example 2

### Preparation of Curing Agent H-2

First of all a reactor equipped with a stirrer was flushed with nitrogen gas. Thereafter 1162.3 mass fractions of a polyisocyanate based on hexamethylene diisocyanate, 108.9 mass fractions of diethyl malonate, 114.4 mass fractions of an aromatic solvent, and 114.4 mass fractions of butyl acetate are added. The mixture was stirred at room temperature for 20 minutes more.

The solids content of the resulting curing agent was 77.5%, with an NCO fraction of 17.1%.

### Example 3

### Preparation of Curing Agent H-3

First of all a reactor equipped with a stirrer was flushed with nitrogen gas. Thereafter 1138.1 mass fractions of a polyisocyanate based on hexamethylene diisocyanate, 213.3 mass fractions of diethyl malonate, 74.3 mass fractions of an aromatic solvent, and 74.3 mass fractions of butyl acetate are added. The mixture was stirred at room temperature for 20 minutes more.

The solids content of the resulting curing agent was 75.9%, with an NCO fraction of 16.8%.

### Example 4

### Preparation of Curing Agent H-4

First of all a reactor equipped with a stirrer was flushed with nitrogen gas. Thereafter 1091.1 mass fractions of a polyisocyanate based on hexamethylene diisocyanate and 408.9 mass fractions of diethyl malonate were added. The mixture was stirred at room temperature for 20 minutes more.

The solids content of the resulting curing agent was 72.7%, with an NCO fraction of 16.1%.

### Example 5

### Preparation of Curing Agent H-5

First of all a reactor equipped with a stirrer was flushed with nitrogen gas. Thereafter 1209.0 mass fractions of a polyisocyanate based on hexamethylene diisocyanate, 226.5 mass fractions of diethyl malonate, and 64.5 mass fractions of acetonitrile were added. The mixture was stirred at room temperature for 20 minutes more.

The solids content of the resulting curing agent was 80.6%, with an NCO fraction of 17.8%.

### Example 6

### Preparation of Curing Agent H-6

First of all a reactor equipped with a stirrer was flushed with nitrogen gas. Thereafter 278.3 of a polyisocyanate based on isophorone diisocyanate and 290.6 mass fractions of diethyl malonate were added and the mixture was stirred at room temperature for 6 hours in order for the polyisocyanate to dissolve. Thereafter 834.3 mass fractions of a polyisocyanate based on hexamethylene diisocyanate and 96.9 mass fractions of acetonitrile were added and the mixture was stirred at room temperature for 20 minutes.

The solids content of the resulting curing agent was 74.2%, with an NCO fraction of 15.5%.

### Example 7

### Comparative Example 1

### Preparation of Curing Agent H-7

First of all a reactor equipped with a stirrer was flushed with nitrogen gas. Thereafter 1209.0 mass fractions of a polyisocyanate based on hexamethylene diisocyanate, 145.5 mass fractions of an aromatic solvent, and 145.5 mass fractions of butyl acetate were added, and the mixture was stirred at room temperature for 20 minutes more.

The solids content of the resulting curing agent was 80.6%, with an NCO fraction of 17.8%.

### Example 8

### Comparative Example 2

### Preparation of Curing Agent H-8

First of all a reactor equipped with a stirrer was flushed with nitrogen gas. Thereafter 879.0 mass fractions of a polyisocyanate based on isophorone diisocyanate, 310.5 mass fractions of an aromatic solvent, and 310.5 mass fractions of butyl acetate were added. The reaction mixture was heated at 120° C. in order for the isophorone diisocyanate-based polyisocyanate to dissolve. Thereafter the batch was cooled to room temperature and stirred for a further 20 minutes.

The solids content of the resulting curing agent was 58.6%, with an NCO fraction of 10.0%.

### Example 9

### Comparative Example 3

### Preparation of Curing Agent H-9

First of all a reactor equipped with a stirrer was flushed with nitrogen gas. Thereafter 831.0 mass fractions of a polyisocyanate based on hexamethylene diisocyanate, 207.0 mass fractions of a polyisocyanate based on isophorone diisocyanate, 231.0 mass fractions of an aromatic solvent, and 231.0 mass fractions of butyl acetate were added and the reaction mixture was heated at 120° C. in order for the isophorone diisocyanate-based polyisocyanate to dissolve. Thereafter the batch was cooled to room temperature and stirred for a further 20 minutes.

The solids content of the resulting curing agent was 69.2%, with an NCO fraction of 14.6%.

### Preparation of the Polyacrylate Polyol PA-1

First of all a reactor equipped with a condenser was flushed with nitrogen gas. Thereafter 720.9 mass fractions of an aromatic solvent were heated to 140° C. with stirring.

In parallel two separate batches were prepared. Batch 1 contained 230.1 mass fractions of styrene, 613.5 mass fractions of butyl methacrylate, and 690.2 mass fractions of 4-hydroxybutyl acrylate. Batch 2 contained 92.0 mass fractions of an aromatic solvent and 153.4 mass fractions of TBPEH.

When a temperature of 140° C. had been reached, batch 2 was added slowly and uniformly over 285 minutes into the reactor containing solvent. 15 minutes after the addition of batch 2, batch 1 was added uniformly over the course of 240 minutes. After the end of the addition of batch 2, the reaction mixture was stirred at 140° C. for a further 120 minutes for the purpose of post-polymerization. The solids content of the resulting product was found to be 61%, the OH number 175 mg KOH/g (based on the solids), and the viscosity 14 dPa·s at 23° C.

### Preparation of the Polyacrylate Polyols PA-2 and PA-3

PA-2 and PA-3 were prepared in accordance with the instructions for PA-1. Only the starting materials were modified:

Mass fraction

| | | PA-2 | PA-3 |
|---|---|---|---|
| Solvent | Aromatic solvent | 616.9 | 609.0 |
| Batch 1 | butyl methacrylate | 81.2 | 80.1 |
| | styrene | 215.9 | 192.3 |
| | 4-hydroxybutyl acetate | 162.3 | 160.3 |
| | 2-ethylhexyl methacrylate | 438.3 | 352.6 |
| | cyclohexyl methacrylate | 141.2 | 128.2 |
| | 2-hydroxypropyl methacrylate | 568.2 | 673.1 |
| | acrylic acid | 16.2 | 16.0 |
| Batch 2 | Aromatic solvent | 97.4 | 96.2 |
| | TBPEH¹⁾ | 162.3 | 192.3 |

¹⁾TBPEH = tert-butyl peroxy-2-ethylhexanoate

The solids fraction of PA-2 was 65.0%, the acid number was 7.8 mg KOH/g, and the OH number was 175 mg KOH/g (acid number and OH number are based on the solids), with a viscosity of 25 dPa·s at 23° C.

The solids fraction of PA-3 was 64.0%, the acid number was 7.8 mg KOH/g, and the OH number was 203 mg KOH/g (acid number and OH number are based on the solids), with a viscosity of 18 dPa·s at 23° C.

### Preparation of the SCA Resin

An SCA resin possesses antisag properties. SCA stands for Sag-Control-Agent.

A 10 I Juvo reaction vessel with heating jacket, thermometer, and stirrer and with top-mounted condenser was charged with 1512.5 g of an aromatic solvent. With stirring under an inert gas atmosphere (200 cm³/min nitrogen), the aromatic solvent was heated under superatmospheric pressure (max. 3.5 bar) to 160° C. With the aid of a measuring pump, a mixture of 80.5 g of di-tert-butyl peroxide and 201.0 g of an aromatic solvent was added dropwise at a uniform rate over the course of 4.75 hours. 0.25 hour after the beginning of the addition, a measuring pump was used to add 1283.5 g of styrene, 1115.0 g of n-butyl acrylate, 693.5 g of hydroxyethyl acrylate, 70.5 g of methacrylic acid, and 43.5 g of dodecyl methacrylate (available under the designation “Methacrylsäureester 13” from Röhm Methacrylate/Evonik) at a uniform rate over the course of 4 hours. After the end of the addition the temperature was held for a further 2 hours and the product was then cooled to 60° C. and filtered through a 5 μm GAF bag. The resulting resin had an acid number of 15 mg KOH/g (according to DIN 53402), a solids content of 65%+/−1 (60 min, 130° C.), and a viscosity of 5.0 dPa·s in accordance with the experimental instructions according to DIN ISO 2884-1 (55% in solvent naphtha).

### Urea Precipitation:

A 1 I reactor was charged with 84.7 g of the resin solution and diluted with 5.88 g of butyl acetate. Then 2.24 g of benzylamine were added and the mixture was stirred for 30 minutes. After this time, with deployment of high shearing forces, a mixture of 1.76 g of hexamethylene diisocyanate and 3.42 g of butyl acetate was added at a rate such that a reaction temperature of 40° C. was not exceeded. The resulting mixture had a viscosity of >800 mPas (10 s⁻¹) (Z3) (DIN ISO 2884-1) and a solids content of 58.6-59.6% (60 min, 130° C.).

### Preparation of the Thixotroping Paste

In a 10 I Juvo reaction vessel with heating jacket, thermometer, and stirrer and with a top-mounted condenser, 3166.1 g of an aromatic solvent were added. Under an inert gas atmosphere (200 cm³/min nitrogen), with stirring and with heating to 156° C., a mixture of 155.9 g of di-tert.-butyl peroxide and 297.4 g of an aromatic solvent was added dropwise from a dropping funnel at a uniform rate over the course of 4.75 hours. 0.25 hour after the addition, a dropping funnel was used for dropwise addition at a uniform rate over 4 hours of a mixture of 829.5 g of styrene, 2041.8 g of n-butyl acetate, 893 g of n-butyl methacrylate, 1276.1 g of hydroxyethyl acrylate, 63.8 g of acrylic acid, and 1276.1 g of 4-hydroxybutyl acrylate. After the end of the addition the temperature was maintained for 2 hours, after which the product was cooled to 80° C. and filtered through a 5 μm GAF bag. The resulting resin had an acid number of 10 mg KOH/g (DIN 53402), a solids content of 65%±1 (60 min, 130° C.), and a viscosity of 20.0 dPa·s as measured in accordance with DIN ISO 2884-1.

A 1 I reactor was charged with 43.8 g of the resin solution, which was diluted with 24.7 g of xylene and 23.4 g of butanol. After 10 minutes, 11.1 g of Aerosil R812 were added with the use of shearing force, and the mixture was exposed to shearing force for a further 30 minutes. The resulting mixture had a viscosity of 130 mPa·s (10 s⁻¹) (Z3) (DIN ISO 2884-1).

### Clearcoat Compositions CC-1 to CC-9

### Component 1

The following batches were prepared in order to provide the first component of the 2-component clearcoat.

| | CC-1 | CC-2 | CC-3 | CC-4 | CC-5 | CC-6 | CC-7 | CC-8 | CC-9 |
|---|---|---|---|---|---|---|---|---|---|
| PA-1 | | | | | | | 51.4 | | |
| PA-2 | | | | | | 48.2 | | | 48.2 |
| PA-3 | 49 | 49 | 49 | 49 | 49 | | | 49 | |
| SCA resin¹ | 5.5 | 5.5 | 5.5 | 5.5 | 5.5 | 5.5 | 5.5 | 5.5 | 5.5 |
| Catalyst containing sulfonic acid | 8.4 | 8.4 | 8.4 | 8.4 | 8.4 | 8.4 | 8.4 | 8.4 | 8.4 |
| Thixotroping paste | 1.3 | 1.3 | 1.3 | 1.3 | 1.3 | 1.3 | 1.3 | 1.3 | 1.3 |
| Butylglycol acetate | 0.3 | 0.3 | 0.3 | 0.3 | 0.3 | 0.3 | 0.3 | 0.3 | 0.3 |
| BGA | 6.1 | 6.1 | 6.1 | 6.1 | 6.1 | 6.1 | 6.1 | 6.1 | 6.1 |
| Melamine resin | 5.8 | 5.8 | 5.8 | 5.8 | 5.8 | 5.8 | 5.8 | 5.8 | 5.8 |
| Dispersing additive | 0.7 | 0.7 | 0.7 | 0.7 | 0.7 | 0.7 | 0.7 | 0.7 | 0.7 |
| Silicone flow control additive | 0.1 | 0.1 | 0.1 | 0.1 | 0.1 | 0.1 | 0.1 | 0.1 | 0.1 |
| Butyl acetate | 4.5 | 4.5 | 4.5 | 4.5 | 4.5 | 4.5 | 4.5 | 4.5 | 4.5 |
| Light stabilizing additive | 2.1 | 2.1 | 2.1 | 2.1 | 2.1 | 2.1 | 2.1 | 2.1 | 2.1 |
| Aromatic solvent mixture | 1 | 1 | 1 | 1 | 1 | 1 | 1 | 1 | 1 |
| Aromatic solvent | 7.4 | 7.4 | 7.4 | 7.4 | 7.4 | 7.4 | 7.4 | 7.4 | 7.4 |
| Butanol | 3.5 | 3.5 | 3.5 | 3.5 | 3.5 | 3.5 | 3.5 | 3.5 | 3.5 |
| Xylol | 5 | 5 | 5 | 5 | 5 | 5 | 5 | 5 | 5 |

¹SCA resin, in partial solution in a mixture of an aromatic solvent/butyl acetate

### Component 2

As the second component the curing agents H1-H9, synthesized in accordance with examples 1-9, were combined with the first component to give the clearcoats CC1-CC9 as per the table below.

| | CC-1 | CC-2 | CC-3 | CC-4 | CC-5 | CC-6 | CC-7 | CC-8 | CC-9 |
|---|---|---|---|---|---|---|---|---|---|
| H-1 | 33 | | | | | | | | |
| H-2 | | 34 | | | | | | | |
| H-3 | | | 35 | | | | | | |
| H-4 | | | | 37 | | | | | |
| H-5 | | | | | 33 | | | | |
| H-6 | | | | | | 40 | | | |
| H-7 | | | | | | | 33 | | |
| H-8 | | | | | | | | 33 | |
| H-9 | | | | | | | | | 40 |

The procedure here was to homogenize 100 parts by weight of component 1 with the parts by weight of component 2 as stated in the table above, and then to apply the mixture as a topmost clearcoat film to the substrate.

The properties of the compositions of the invention were tested with regard to their optical surface quality (appearance) and their hardness properties. For this purpose, metal test plates were coated first with a commercially available and electrically cathodically deposited, then thermally cured coating material. Over that a commercially available surfacer was applied and subjected to thermal curing. A commercially available black basecoat from BASF Coatings AG was applied to the surfacer and flashed off at 80° C. for 10 minutes. The clearcoat of the invention was applied over that and cured together with the basecoat at 140° C. for 22 minutes. The resulting basecoat had a film thickness of 7.5 μm and the resulting clearcoat had a film thickness of approximately 35 μm. The film thickness here was measured by means of a MiniTest 4100 instrument from ElektroPhysik. The coated steel substrates were measured by the magnetic induction method based on DIN 50981. The test plates were tested for their surface quality and hardness.

### Clearcoat Properties of Clearcoats CC-1 to CC-6

| | Inventive examples | | | | | |
|---|---|---|---|---|---|---|
| | CC-1 | CC-2 | CC-3 | CC-4 | CC-5 | CC-6 |
| Optical surface quality | 2 | 2 | 2 | 2 | 2 | 2 |
| (appearance)¹ | | | | | | |
| Mattness (appearance)² | 1 | 1 | 1 | 1 | 1 | 1 |
| Longwave (appearance)² | 5.5 | 5.5 | 4.0 | 3.1 | 3.2 | 4.0 |
| Shortwave (appearance)² | 12.7 | 12.7 | 12.5 | 12.3 | 12.4 | 11.3 |
| Micro hardness [N/mm²]³ | 117 | 115 | 112 | 114 | 115 | 130 |
| AMTEC residual gloss in [%] | 77 | 75 | 73 | 78 | 77 | 75 |
| after cleaning⁴ | | | | | | |

¹Determined by visual inspection of a cured coating: 0 = uneven surface; poor optical surface quality; 1 = very matt surface, poor optical surface quality; 2 = smooth surface, very good optical surface quality
²Determined using a Wavescan-DOI instrument from BYK-Chemie
³Determined in agreement with DIN EN ISO 14577. A Fischerscope instrument from Fischer Messtechnik was used, with a maximum force of 25.6 mN.
⁴Determined in accordance with DIN 67530 in 20° geometry.

### Clearcoat Properties of Clearcoats CC-7 to CC-9

| | Comparative examples | | |
|---|---|---|---|
| | CC-7 | CC-8 | CC-9 |
| Optical surface quality (appearance)¹ | 1 | 0 | 0 |
| Mattness (appearance)² | 46.3 | 1.5 | 1 |
| Longwave (appearance)² | 15.8 | 6.8 | 5.3 |
| Shortwave (appearance)² | 26.2 | 12.2 | 11.4 |
| Micro hardness [N/mm²]³ | 86 | 115 | 131 |
| AMTEC residual gloss in [%] after cleaning⁴ | / | 75 | 73 |

¹Determined by visual inspection of a cured coating: 0 = uneven surface; poor optical surface quality; 1 = very matt surface, poor optical surface quality; 2 = smooth surface, very good optical surface quality
²Determined using a Wavescan-DOI instrument from BYK-Chemie
³Determined in agreement with DIN EN ISO 14577. A Fischerscope instrument from Fischer Messtechnik was used, with a maximum force of 25.6 mN.
⁴Determined in accordance with DIN 67530 in 20° geometry.

The inventive clearcoats CC1-CC6 exhibit outstanding gloss and have very good hardness properties. The comparative coatings CC7-CC9 have an inadequate gloss which is not up to the requirements made of modern clearcoats.

1. A coating composition comprising
(a) a binder comprising OH groups and
(b) at least one curing agent comprising at least one aliphatic polyisocyanate
(b1), wherein the binder component (a) and/or the curing agent component
(b) comprises at least one CH-acidic compound (b2).

2. The coating composition of claim 1, wherein the curing agent comprises a mixture of at least one aliphatic polyisocyanate (b1) and of at least one CH-acidic compound (b2).

3. The coating composition of claim 1, wherein the curing agent (b) further comprises at least one polymeric amine (c).

4. The coating composition of claim 3, wherein the fraction of component (c) is from 1%-4% by weight, based on the overall formulation of the curing agent.

5. The coating composition of claim 1, wherein the molar ratio of the reactive OH groups of the binder (a) to the reactive unblocked NCO groups of the polyisocyanate is 0.1:1 to 1:0.9.

6. The coating composition of claim 1, wherein the ratio of the weight fractions of components (b1) and (b2) is between (b1):(b2)=15:1 and (b1):(b2)=1.5:1.

7. The coating composition of claim 1, wherein the at least one aliphatic polyisocyanate is an isocyanurate-based oligomeric or polymeric derivative of one or more aliphatic polyisocyanates

8. The coating composition of claim 1, wherein the at least one CH-acidic compound (b2) has a molecular weight of 90-400 g/mol.

9. The coating composition of claim 1, wherein the at least one CH-acidic compound (b2) is selected from the group of B-dicarbonyl compounds.

10. The coating composition of claim 3, wherein the at least one polymeric amine (c) has a molecular weight Mw of 1000-50 000 g/mol.

11. The coating composition of claim 3, wherein the at least one polymeric amine (c) has an amine number of 2-40 mg KOH/g.

12. A method of coating a substrate with a clearcoat, comprising applying the coating composition of claim 1 that is a clearcoat to the substrate.

13. A clearcoat comprising the coating composition of claim 1.

14. The clearcoat of claim 13, which is curable solely thermally or with actinic radiation.

15. The clearcoat of claim 13, which is a two-component or multicomponent clearcoat.

16. The method of claim 12 wherein the substrate is an automobile body or part thereof.

17. An automobile body or part thereof provided with a coating comprising the clearcoat of claim 13.

18. The coating composition of claim 7, wherein the at least one aliphatic polyisocyanate is an isocyanurate-based oligomeric or polymeric derivative of hexamethylene diisocyanate and/or isophorone diisocyanate.

19. The coating composition of claim 10, wherein the at least one polymeric amine (c) has a molecular weight Mw of 1000-20 000 g/mol.

20. The coating composition of claim 11, wherein the at least one polymeric amine (c) has an amine number of 5-30 mg KOH/g.
